(19) United States
(12) Patent Application Publication
(10) Pub. No.: US 2003/0074924 A1
(43) Pub. Date: Apr. 24, 2003

(54) Method and apparatus for forming a lens on an optical fiber

(76) Inventors: Charles David Melville, Issaquah, WA (US); Richard S. Johnston, Sammamish, WA (US)

Correspondence Address: ALL OPTICAL NETWORKS, INC., 9440 CARROLL PARK DRIVE, SAN DIEGO, CA, 92121, US

(21) Appl. No.: 10/155,308

(22) Filed: May 22, 2002

Related U.S. Application Data
(60) Provisional application No. 60/346,503, filed on Oct. 19, 2001.

(51) Int. Cl. C03B 37/15

(52) U.S. Cl. 65/387

(57) ABSTRACT

Method and Apparatus for Forming a Lens on an Optical Fiber includes a fiber rotator assembly that receives and axially rotates an optical fiber. The optical fiber is positioned through a fiber support assembly that includes an air bearing for the near frictionless rotation of the fiber. A fiber forming assembly is positioned adjacent the end of the optical fiber and includes an abrasive disc mounted to the shaft of an abrasive disc motor. The fiber forming assembly is advanced toward the rotating optical fiber for the rotating abrasive disc to contact and remove a portion of the tip of the fiber forming a cone having a predetermined cone angle. A fiber profiling tool having a flexible abrasive flap is advanced to contact the cone-shaped tip of the rotating fiber to remove a portion of the cone to form a lens on the end of the fiber.

### RELATED APPLICATIONS

This application claims the benefit of priority of Provisional Patent Application Serial No. 60/346,503, filed Oct. 19, 2001, currently co-pending.

### FIELD OF THE INVENTION

The present invention relates generally to the telecommunications industry. More specifically, the present invention relates to the task of interfacing optical fibers in a fiber optic telecommunications network. The present invention is particularly, though not exclusively, useful for forming a spherical lens on the end of an optical fiber.

### BACKGROUND OF THE INVENTION

In optical telecommunication networks, flexible optical fibers are used to route light signals through the optical network and between telecommunication equipment. These fibers are typically made with a transparent core with a first index of refraction, covered by a cladding layer having a differing index of refraction to maximize the internal reflection of the light signal within the core itself. The efficient insertion and removal of light from the core of an optical fiber is essential to the transmission of these light signals, and the successful operation of these optical networks.

There are two primary types of optical fibers in use today, namely, single mode fibers and multi-mode fibers. The typical outer diameter of both single and multi-mode fibers is 125 microns. Single mode fibers are formed with a core having a diameter of approximately 10 microns, and multi-mode fibers are formed with a core having a diameter of approximately 60 microns. Because of the small diameters of the cores of these fibers, significant attention has to be directed to the proper alignment of optical fibers within an optical system.

Over the last several years, it has been found that the incorporation of a small lens, or lenslet, adjacent the end of an optical fiber facilitates the insertion and removal of light signals into or out of optical fibers. In some cases, the fibers are placed adjacent a lens such that the light diverging from the end of an optical fiber is passed through the lens to focus the light to form a beam in order to mode-field match the light beam from the fiber to a waveguide having a small mode field diameter.

Unfortunately, this method of coupling a light signal into or out of an optical fiber requires precise alignment between the end of the optical fiber and the small lens. In fact, since the core of a single mode fiber is approximately 10 microns in diameter, a slight deviation in position between the fiber end and the small lens may result in a significant loss of the light signal.

As an alternative to the use of a small lens adjacent the fiber end, several attempts have been made to form a lens directly on the end of the optical fiber. While the formation of a lens on the end of an optical fiber may serve to decrease the precision required for the alignment of the fiber within the telecommunications system, the formation of such a lens is very difficult. This difficulty is due in large part to the flexible nature of the fiber, the small diameter of the fiber, and the requirement that the lens be properly formed to maximize the light insertion and removal characteristics of the fiber.

One method of forming a lens on an optical fiber includes the etching of the fiber end using an acid wash. This etching is achieved by the repeated dipping of the end of the optical fiber into an acid wash, which removes a portion of the tip of the fiber. While the etching process does in fact remove a portion of the fiber thereby re-shaping the fiber tip, this process does not result in the formation of a spherical lens. Rather, the etching method of forming a lens results in a conical shaped lens that only marginally improves the insertion into or removal of optical signals from the optical fiber. Also, the etching process is uncontrollable, and requires the use of hazardous chemicals.

An alternative method of forming a lens on an optical fiber includes the exposure of the tip of the optical fiber to a heat source sufficient to melt the end of the optical fiber. Like the etching method, the melting of the end of the optical fiber reshapes the fiber tip. However, the resulting shape is difficult to predict and is often less useful than the original flat-tipped fiber.

Yet another alternative method of forming a lens on an optical fiber includes the coating of the end of the optical fiber. One such example of forming a lens by coating the end of the fiber is described in U.S. Pat. No. 4,338,352 that issued in 1982 to Philip Bear et. al. for an invention entitled “Process for producing guided wave lens on optical fiber”. The Bear process includes the coupling of a laser light source, such as a HeNe laser, into one end of an optical fiber, and then repeatedly dipping the other end of the optical fiber into a photoresist. The HeNe light source polymerizes the photoresist to form a lens on the end of the fiber.

While the coating method of forming a lens on an optical fiber may result in the formation of a lens-shaped polymer on the end of a fiber, there is very little control over the particular shape of that lens. In fact, since the outer diameter of the optical fiber is approximately 125 microns, the lens formed on the fiber end has a much larger diameter than is typically useful in today's telecommunication systems.

In light of the above, there is a need for an apparatus and method for forming a lens on an optical fiber which can form a spherical lens having a particular shape, that is easy to perform, and is highly repeatable.

### SUMMARY OF THE INVENTION

The present invention includes an apparatus and method for forming a lens on an optical fiber. The apparatus includes a fiber rotator assembly that receives and axially rotates an optical fiber. The optical fiber is positioned through the fiber rotator assembly and through a fiber support assembly that includes an “air” bearing for the near frictionless rotation of the fiber. Once the fiber is in position through the fiber rotator assembly and the fiber support assembly, the optical fiber may be axially rotated.

A fiber forming assembly is positioned adjacent the end of the optical fiber and includes an abrasive disc mounted to the shaft of an abrasive disc motor. The abrasive disc motor may be energized to rotate the abrasive disc, and as the abrasive disc is rotating, the fiber forming assembly is advanced toward the rotating optical fiber to contact and remove a portion of the tip of the fiber to form a cone having a predetermined cone angle.

Once a suitable cone is formed on the end of the optical fiber, the fiber forming assembly is removed, and a fiber profiling tool is positioned adjacent the rotating optical fiber. The fiber profiling tool is formed with a flexible abrasive flap. As the optical fiber is rotating, the fiber profiling tool is advanced such that the flexible abrasive flap contacts the cone-shaped tip of the rotating fiber to remove a portion of the cone to form a lens on the end of the fiber. The abrasive flap may be changed to a finer abrasive in order to polish the lens on the end of the fiber.

### BRIEF DESCRIPTION OF THE DRAWINGS

FIG. 1 is a system diagram showing the fiber rotator assembly for axially rotating the fiber, the fiber support assembly for holding the rotating fiber, and the abrasive disc and motor used to shape the end of the rotating optical fiber to form a cone-shaped tip;

FIG. 2 is a system diagram showing the fiber rotator assembly for axially rotating the fiber, the fiber support assembly for supporting the rotating fiber, and the profiling tool having a flexible abrasive flap used to polish the end of the rotating optical fiber to form a lens having a particular radius of curvature;

FIG. 3 is a detailed side view of the profiling tool being advanced from a first position to a second position to polish the end of the rotating optical fiber to form a lens having a particular radius of curvature;

FIG. 4 is a side view of the end of an optical fiber that has been formed to have a lens;

FIG. 5 is a flow chart representing the process steps for forming a lens on the end of an optical fiber; and

FIG. 6 is a system diagram of an alternative embodiment of the present invention showing the fiber rotator assembly for axially rotating the fiber, the fiber support assembly for supporting the rotating fiber, and the profiling tool having a flexible abrasive flap used to polish the end of the rotating optical fiber to form a lens having a particular radius of curvature, and an automated polishing system having a machine vision apparatus and a motion controller for the computercontrolled forming of a lens on the end of an optical fiber.

### DETAILED DESCRIPTION

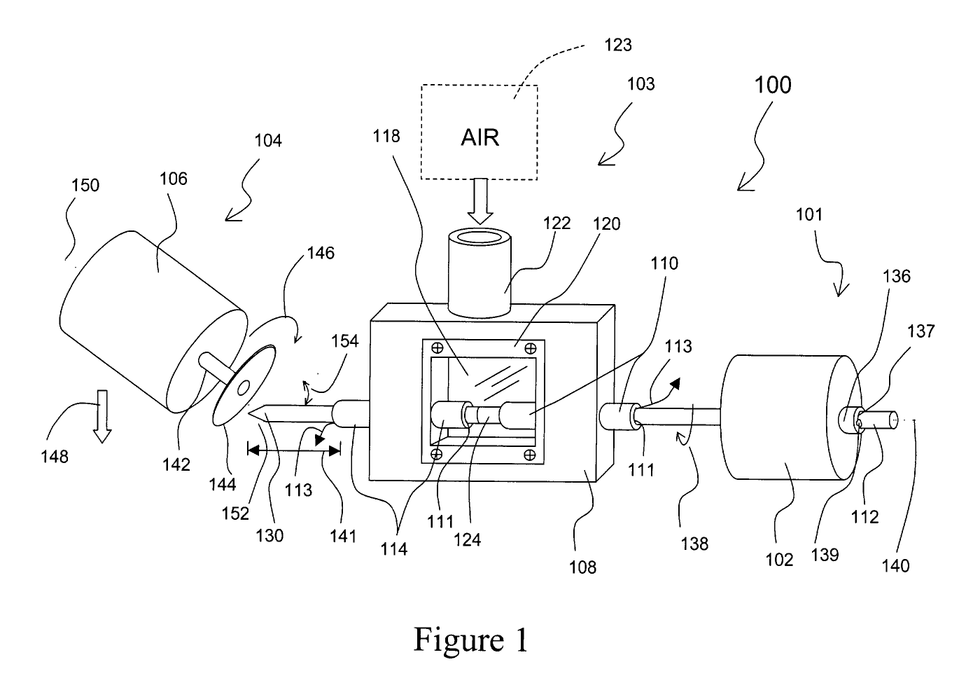

Referring initially to FIG. 1, an apparatus for forming a lens on an optical fiber is shown and generally designated 100. Apparatus 100 includes a fiber rotating assembly 101 having a motor 102, a fiber support assembly 103 and a fiber forming assembly 104 having a disc motor 106.

Fiber support assembly 103 provides support to an optical fiber during the lens-forming procedure, and includes an “air” bearing chassis 108 formed with an air bearing sleeve 110 having a bore 111 sized to receive optical fiber 112. Air bearing sleeve 110 leads into a pressure chamber 118 that may be covered with plate 120 to form the positive pressure chamber 118 within chassis 108. Plate 120 may be transparent to allow for a visible verification that no contaminates are being introduced into the fiber support assembly 103. Air bearing sleeve 114 leads from pressure chamber 118 and is likewise formed with a bore 111 to receive optical fiber 112.

Fiber support assembly 103 is also formed with an gas supply line 122 which leads to pressure chamber 118. In use, pressurized air from pressurized air source 123 is applied to gas supply line 122 which in turn creates a pressure gradient across the air bearing sleeves, causing air to flow from chamber 118 into air bearing sleeves 110 and 114, and out past fiber 112 in direction 113. The air passing from positive pressure chamber 118 out through air bearing sleeves 110 and 114 provides for an air bearing to be created between fiber 112 and air bearing sleeves 110 and 114 allowing for the near frictionless rotation of optical fiber 112. In addition, the air flowing out of the air bearing sleeves 110 and 114 in direction 113 will carry with it any abrasive particles that might otherwise cause damage to the exterior coating of the optical fiber 112.

In a preferred embodiment, buffer layer 124 may be removed from fiber 112. FIG. 1 shows the buffer layer 124 removed from the fiber 112 beginning within positive pressure chamber 118, however, it may be removed more proximal to end 130, or anywhere along the length of the fiber 112. It is to be appreciated that the diameter of fiber 112 will be less if buffer layer 124 is removed, and thus, the diameter of air bearing sleeve 114 may be different from the diameter of air bearing sleeve 116.

As discussed herein, pressurized air source 123, may supply air, for example. However, it is also to be appreciated that alternative gasses may be introduced into gas supply line 122. For-instance, pressurized Nitrogen may be provided, alone or in combination with air. Also, other gasses known in the art may be used without departing from the present invention. Further, although various items described herein have been identified using “air” in their title, such as “air bearing”, “air bearing sleeves”, no limitations whatsoever as to the particular gasses are to be implied from such titles.

As shown in FIG. 1, the fiber rotator assembly 101 includes fiber motor 102 having a fiber motor shaft 136 formed with an axial bore 137 sized to receive optical fiber 112 through the motor shaft 136. By energizing fiber motor 102 to rotate, optical fiber 112 may be rotated in direction 138 along axis 140. Direction arrow 138 indicates the rotation of fiber 112 in a first direction, however, it is to be appreciated that the direction of rotation of motor may be reversed causing fiber 112 to rotate in an opposite direction.

In order to secure fiber 112 to fiber motor shaft 136, an adhesive 139 may be placed between fiber 112 and motor shaft 136. In a preferred embodiment, the adhesive may be removable to provide for the easy attachment and removal of fiber 112 from motor shaft 136. This adhesive may be a hot-melt glue, which may be simply heated for easy removal of the fiber 112 from fiber motor shaft 136. Further, other adhesive materials known in the art, including an epoxy or glue may be used. Alternatively, motor shaft 136 may be equipped with a chuck in order to secure fiber 112 within motor shaft 136.

Optical fiber 112 is positioned in fiber support assembly 103 of apparatus 100 such that the fiber end 130 extends from air bearing sleeve 114 a distance 141. Distance 141, in a preferred embodiment, is approximately 300 microns. Once optical fiber 112 is positioned in fiber support assembly 103, fiber forming assembly 104 is positioned adjacent end 130 of the fiber. Fiber forming assembly 104 includes an abrasive disc motor 106 having a motor shaft 142 supporting an abrasive disc 144. Once energized, abrasive disc motor 106 rotates motor shaft 142 in direction 146 about disc motor axis 150.

As the abrasive disc 144 is rotating in direction 146 and fiber 112 is rotating in direction 138, fiber forming assembly 104 is moved in direction 148 such that rotating abrasive disc 144 is brought into contact with fiber end 130. As fiber end 130 contacts abrasive disc 144, the fiber 112 deflects, or bends, away from axis 140. As this bending begins to occur, fiber forming assembly 104 is retreated in an opposite direction to direction 148 until fiber 112 returns to its original straightened position, and then the fiber forming assembly 104 is once again advanced toward fiber 112 to repeat the process.

Each time rotating disc 144 advances in direction 148, a portion 152 of fiber end 130 is abrasively removed to form a cone-shaped tip having a cone angle 154. Due to the flexible nature of fiber 112, as the rotating abrasive disc 144 contacts fiber 112, there is little chance the optical fiber 112 will break, however, the fiber provides an urging force against the rotating abrasive disc 144 to provide a cone angle 154 that is axially symmetrical.

The directions 138 and 146 shown in FIG. 1 are merely exemplary of a preferred embodiment, however, these directions may be reversed separately or together. In circumstances where substantial fiber forming is necessary to fiber end 130, it is advantageous to have direction 138 opposite to direction 146 as this provides for the greatest differential velocity between abrasive disc 144 and fiber 112, and results in the rapid removal of portions 152 of fiber 112. Alternatively, in circumstances where only minimal fiber forming is necessary, direction 138 may be the same as direction 146 to minimize the differential velocity between abrasive disc 144 and fiber 112 and to remove only minor portions of fiber 112.

From FIG. 1 it can be appreciated that the orientation of disc motor axis 150 of disc motor 106 determines the cone angle 154 formed on the end 130 of optical fiber 112. In a preferred embodiment, cone angle 154 is thirty degrees (30°), with alternative embodiments of the present invention providing cone angles ranging from five to fifty degrees (5°-50°). While specific cone angles 154 have been discussed herein, it is to be appreciated that the present invention is not limited to such angles, rather, the present invention is capable of achieving any cone angle ranging from nearly zero degrees to nearly ninety degrees (˜0°-˜90°).

In some applications, the formation of a precisely polished cone angle 154 on fiber 112 is sufficient to direct light into or from fiber 112 in an optical system. However, should additional light direction be necessary, once an acceptable cone angle 154 has been formed on end 130 of fiber 112, a lens may be formed on end 130 of the fiber 112.

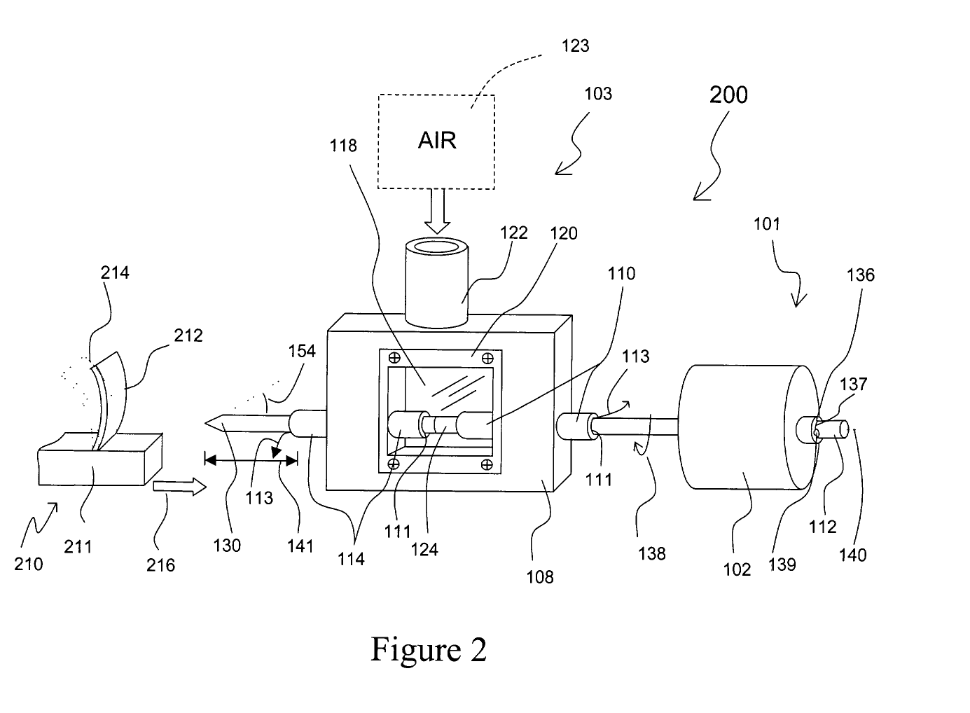

Referring now to FIG. 2, a system 200 is shown and includes the fiber rotator assembly 101, the fiber support assembly 103, and the fiber profiling tool 210 for forming a lens on the end of fiber 112. Fiber profiling tool 210 includes a base 211 having a flexible abrasive flap 212 that is used to polish the end 130 of the rotating optical fiber 112 to form a lens having a particular radius of curvature.

In use, while optical fiber 112 is rotated in direction 138, the fiber profiling tool 210 is advanced in direction 216 such that the flexible abrasive flap 212 contacts end 130 of fiber 112. As tool 210 is advanced further in direction 216, the flexible abrasive flap 212 is moved to its deflected position 214.

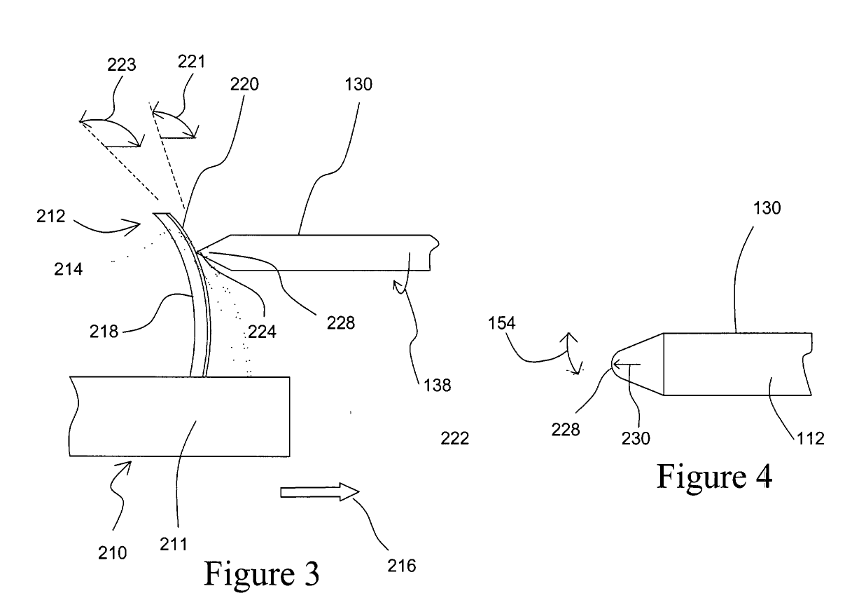

FIG. 3 shows a more detailed view of the fiber profiling tool 210 as it is being advanced in direction 216 from a first position, to a second deflected position 222 where the flexible abrasive flap 212 is deflected to deflected position 214 (shown in dashed lines). By advancing the fiber profiling tool 210 in direction 216, the end 130 of the rotating optical fiber 112 is polished to remove the tip portion 224 thereby forming a lens 228 on the end 130 of the fiber 112.

As shown in FIG. 3, flexible abrasive flap 212 is shown having a substrate material 218 and an abrasive coating 220. In a preferred embodiment, substrate material 218 is hard polyester film. Also in a preferred embodiment, abrasive coating 220 includes aluminum oxide having a 0.3 micron grit for coarse abrasion, 0.05 micron grit for fine abrasion, or diamond particles having a suitable grit size. It is to be appreciated that any abrasive known in the art may be used, and that the abrasive materials discussed above are merely exemplary of a preferred embodiment.

One benefit of using a flexible abrasive flap 212 in the present invention includes the variable angle of incidence the optical fiber 112 experiences when exposed to the fiber profiling tool 210. More specifically, as the optical fiber 112 initially contacts the flexible abrasive flap 212, the initial angle of incidence 221 of the fiber 112 to the flexible abrasive flap 212 is near perpendicular, or within a small angle ranging between three and five degrees (3°-5°) from perpendicular. However, as the fiber profiling tool 210 is advanced in direction 216, the flexible abrasive flap 212 deflects toward position 214, and the angle of incidence 223 between the optical fiber 112 and the flexible abrasive flap 212 increases. An acceptable range for angle of incidence 223 is between ninety and one hundred fifty degrees (90°-150°), however, it is to be appreciated that other angles can be used.

FIG. 4 shows a side view of the end 130 of an optical fiber 112 that has been formed to have cone angle 154 leading to a lens 228 having a radius of curvature 230. In a preferred embodiment, the radius of curvature 230 is approximately eight microns (8μ), but may range from four to twenty microns (4-20μ). As a result of this radius of curvature on lens 228, an optical fiber 112 made in conjunction with the present invention will provide superior light directing capabilities than competing fiber finishing techniques. Moreover, because lens 228 is formed directly onto the end 130 of optical fiber 112, there are fewer alignment challenges to overcome when integrating an optical fiber 112 into an optical system.

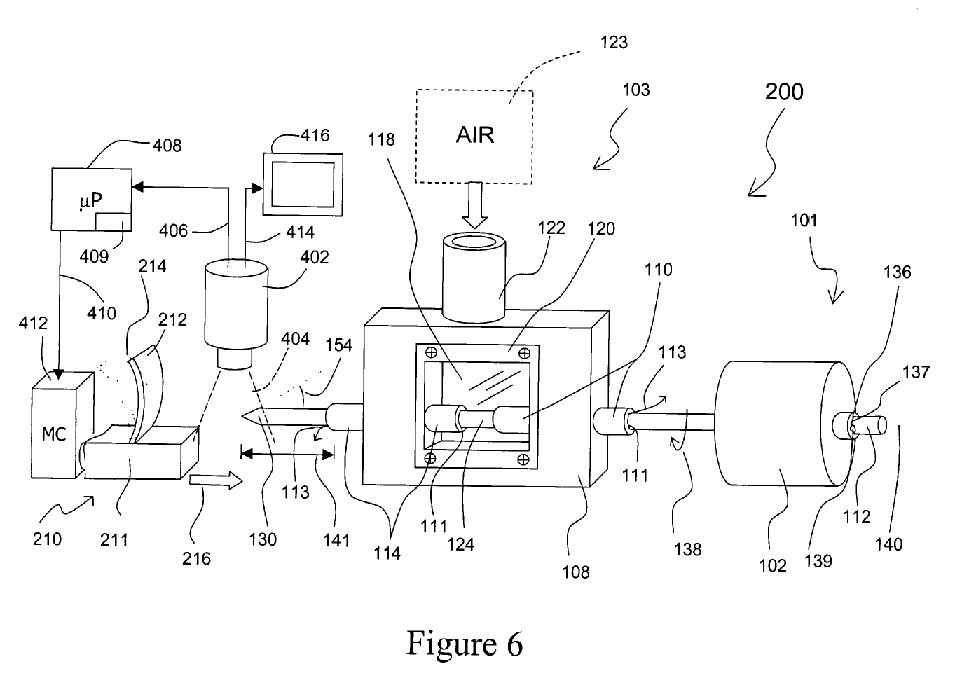

Referring ahead to FIG. 6, an alternative embodiment of a portion of system 200 of the present invention is shown and generally designated 200. System 200 includes the fiber rotator assembly 101, the fiber support assembly 103, and the fiber profiling tool 210 for forming a lens on the end of fiber 112, and an automated control system 400. Automated control system 400 includes a machine vision apparatus 402, such as a microscope, having a field of view 404 directed to fiber end 130 of fiber 112 as positioned within fiber rotator assembly 103. Output 406 from machine vision apparatus 402 may be electrically connected via connection 406 to microprocessor 408. A control signal may be generated in microprocessor 408 and communicated via connection 410 to a motion control device 412 in mechanical connection with fiber profiling tool 210.

The automated use of system 200 includes the imaging of end 130 of fiber 112 by machine vision apparatus 402 as it contacts abrasive flap 220. The image from machine vision apparatus 402 is communicated to microprocessor 408, which determines a radius of curvature 230 of lens 228. Once the radius of curvature 230 is measured, the measured curvature may be compared to an actual or desired curvature value stored in memory 409. Based on this comparison, a control signal may be generated by microprocessor 408 and communicated to motion control device 412 to advance fiber profiling tool 210 in direction 216 to abrasively remove more of fiber end 130, or retreat fiber profiling tool opposite to direction 216.

Automated control system 400 provides system 200 the immediate feedback capability in order to quickly and efficiently form lens 228 on fiber 112. By establishing a goal, or desired, radius of curvature of lens 228, control system 400 can compare a measured radius of curvature 230 derived from data obtained from machine vision apparatus 402 to the desired radius from memory 409 to determine what additional abrasion is necessary. Using this approach, a precise radius of curvature 230 of fiber lens 228 may be achieved.

Another alternative embodiment of the present invention includes system 200 and a machine vision apparatus 402, such as a microscope. An operator of the present invention may view the end 130 of fiber 112 through the microscope and advance fiber profiling tool 210 in direction 216 manually to polish fiber end 130, or retreat fiber profiling tool 210 once sufficient polishing has been accomplished. This process may be repeated with fiber profiling tools 210 having the same or differing abrasive materials in order to achieve the desired radius of curvature 130 of lens 228. Machine vision apparatus 402 may provide an output 414 to a display device 416 to provide the operator with an enlarged view of the fiber lens 228, thereby facilitating the formation of a lens 228 having a proper curvature.

Method of the Present Invention

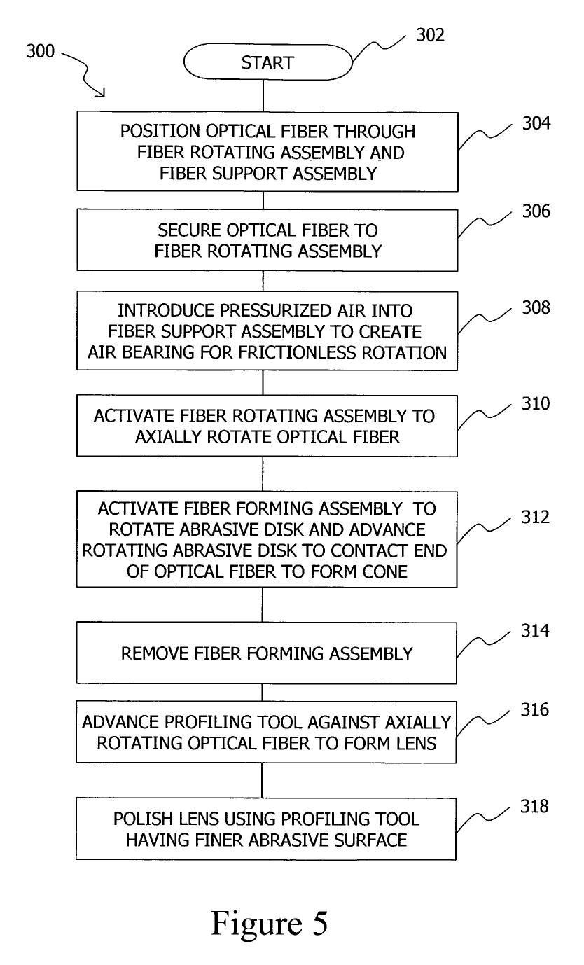

Referring now to FIG. 5, a flow chart representing the method steps for forming a lens on the end of an optical fiber is shown and generally designated 300. Method 300 begins in step 302 and proceeds with step 304 in which an optical fiber 112 is positioned through the fiber rotating assembly 101, and is inserted through fiber support assembly 103 such that the end 130 protrudes from the air bearing sleeve 114 a distance 141 sufficient to allow fiber 112 to flex slightly. Once fiber 112 is positioned, in step 306, optical fiber 112 is secured to fiber rotating assembly 101, such as with an adhesive. In step 308, pressurized air is introduced into the gas supply line 122 of the fiber support assembly 103 to create an air bearing between fiber 112 and air bearing sleeves 110 and 114 providing for the near frictionless rotation of fiber 112.

In step 310, fiber rotator assembly 101 is activated to rotate fiber 112 in direction 138. Next, in step 312 fiber forming assembly 104 is energized to rotate abrasive disc 144, and once rotating, the abrasive disc 144 is advanced in direction 148 such that the rotating abrasive disc 144 contacts tip 130 of fiber 112 to remove a portion of the fiber 112 to form a cone angle 154.

In step 314, the fiber forming assembly 104 is removed in preparation of step 316 which includes the positioning of profiling tool 210 adjacent fiber end 130. In step 316, as the optical fiber 112 rotates axially, the profiling tool 210 is moved in direction 216 such that the flexible abrasive flap 212 contacts fiber end 130 of rotating fiber 112 and is deflected to a deflected position 214. By repeatedly contacting the rotating fiber end 130 with the profiling tool, tip 130 becomes rounded to form a lens 228 (shown in FIG. 4). If necessary, step 318 includes the polishing of end 130 of optical fiber 112 using a profiling tool 210 having an abrasive flap 212 with a finer abrasive coating 220, often said to have a polishing grit, to form a lens 228 having a particular radius of curvature 230.

The present invention may be embodied in other specific forms without departing from its spirit or essential characteristics. The described embodiments are to be considered in all respects only as illustrative, and not restrictive, and the scope of which is limited only by the appended claims.

What is claimed and desired to be secured by United States Letters Patent is:

1. An apparatus for forming a lens on an optical fiber, comprising:
a fiber rotating assembly having a motor 102 formed with an axial bore sized to receive an optical fiber;
a fiber support assembly having an air bearing chassis having a positive pressure chamber and a first air bearing sleeve and a second air bearing sleeve, wherein said first and second air bearing sleeves are substantially axially aligned and formed with a bore sized to receive an optical fiber;
a fiber forming assembly having a disc motor having a shaft and a rotating abrasive disc attached to said shaft;
wherein said optical fiber is passable through said axial bore of said fiber rotating assembly and said air bearing sleeves of said fiber support assembly for contacting said rotating abrasive disc to remove a portion of said fiber.

2. The apparatus for forming a lens on an optical fiber of claim 1, wherein said air bearing chassis further comprises a gas supply line for receiving pressurized air from a pressurized air source to create a pressure gradient across the air bearing sleeves

3. The apparatus for forming a lens on an optical fiber of claim 2 wherein said pressurized air source provides air.

4. The apparatus for forming a lens on an optical fiber of claim 2, wherein said pressurized air source provides a gas other than air.

5. The apparatus for forming a lens on an optical fiber of claim 1, wherein said fiber motor has a fiber motor shaft formed with an axial bore sized to receive an optical fiber through said motor shaft, whereby energizing said fiber motor to rotate causes said optical fiber within said axial bore to rotate.

6. The apparatus for forming a lens on an optical fiber of claim 5, further comprising an adhesive placed between said fiber and said motor shaft to secure said fiber therein.

7. The apparatus for forming a lens on an optical fiber of claim 5, wherein said motor shaft further comprises a chuck to secure said fiber within said motor shaft.

8. The apparatus for forming a lens on an optical fiber of claim 1, wherein said optical fiber has an axis and wherein said disc motor has an axis, and wherein said axis of said disc motor is not parallel to said axis of said disc motor.

9. The apparatus for forming a lens on an optical fiber of claim 8, wherein said axis of said disc motor and said axis of said optical fiber form a cone angle, wherein said cone angle is between five and fifty degrees.

10. The apparatus for forming a lens on an optical fiber of claim 8, wherein said axis of said disc motor and said axis of said optical fiber form a cone angle, wherein said cone angle is between zero and ninety degrees.

11. An apparatus for forming a lens on an optical fiber, comprising:
a fiber rotating assembly having a motor formed with an axial bore sized to receive an optical fiber;
a fiber support assembly having an air bearing chassis having a positive pressure chamber and a first air bearing sleeve and a second air bearing sleeve, wherein said first and second air bearing sleeves are substantially axially aligned and formed with a bore sized to receive an optical fiber;
a fiber profiling tool having an abrasive flap; and
wherein said optical fiber is passable through said axial bore of said fiber rotating assembly and said air bearing sleeves of said fiber support assembly for contacting said abrasive flap of said fiber profiling tool to remove a portion of said fiber.

12. The apparatus for forming a lens on an optical fiber of claim 11, wherein said fiber profiling tool further comprises a flexible abrasive flap.

13. The apparatus for forming a lens on an optical fiber of claim 12, wherein said flexible abrasive flap is deflectable between a first position and a second position.

14. The apparatus for forming a lens on an optical fiber of claim 13 wherein said first position is substantially perpendicular to said axis of said optical fiber.

15. The apparatus for forming a lens on an optical fiber of claim 13 wherein said second position is between ninety and one hundred fifty degrees from said axis of said optical fiber.

16. The apparatus for forming a lens on an optical fiber of claim 11, wherein said abrasive flap of said fiber profiling tool further comprises a substrate and an abrasive coating on said substrate.

17. The apparatus for forming a lens on an optical fiber of claim 16, wherein said substrate material comprises a hard polyester film.

18. The apparatus for forming a lens on an optical fiber of claim 16, wherein said abrasive coating comprises aluminum oxide.

19. The apparatus for forming a lens on an optical fiber of claim 16, wherein said abrasive coating comprises an abrasive having a grit between 0.3 microns and 0.05 microns.

20. The apparatus for forming a lens on an optical fiber of claim 16, wherein said abrasive material comprises diamond particles

21. A method of forming a lens on an optical fiber, comprising the steps of:
positioning an optical fiber having an end through a fiber rotating assembly;
inserting said optical fiber through a fiber support assembly having an air bearing sleeve, wherein the end protrudes from said air bearing sleeve a distance sufficient to allow said fiber to flex slightly;
introducing pressurized air into said fiber support assembly to create an air bearing between said optical fiber and said air bearing sleeve;
activating said fiber rotating assembly to axially rotate said optical fiber;
advancing a rotating abrasive disc such that the rotating abrasive disc contacts said tip of said optical fiber to remove a portion of said optical fiber to form a cone angle.

22. A method of forming a lens on an optical fiber of claim 21, further comprising:
removing said fiber forming assembly;
positioning a profiling tool adjacent said end of said optical fiber;
advancing said profiling tool to contact said end of said optical fiber to polish said cone angle to form a lens.

23. A method of forming a lens on an optical fiber of claim 22, wherein said profiling tool comprises a flexible abrasive flap, and wherein said advancing of said profiling tool contacts said cone angle of said rotating optical fiber to move said flexible abrasive flap from a initial position having a first angle of incidence to a deflected position having a second angle of incidence to form a lens having a spherical surface.
